(19) United States
(12) Patent Application Publication
(10) Pub. No.: US 2007/0134524 A1
(43) Pub. Date: Jun. 14, 2007

(54) Fuel cell stack structure

(76) Inventors: Kyu-Taek Cho, Yongin-si (KR); Yoo-Chang Yang, Yongin-si (KR); Jong-Hyun Lee, Seongnam-si (KR); Tae-Won Lim, Yongin-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/636,699

(22) Filed: Dec. 8, 2006

(30) Foreign Application Priority Data
Dec. 9, 2005 (KR) 10-2005-0121086

(51) Int. Cl. H01M 8/24

(52) U.S. Cl. 429/18

(57) ABSTRACT

A fuel cell stack structure comprising a unit module, common distributor, and bus bar is disclosed. The unit module comprises fuel cells, current collecting plates, insulating plates, end plates, and fixing bands.

### CROSS-REFERENCE TO RELATED APPLICATIONS

The present application is based on, and claims priority from, Korean Application Serial Number 10-2005-0121086, filed on Dec. 9, 2005, the disclosure of which is hereby incorporated by reference herein in its entirety.

### TECHNICAL

The present invention relates to the structure of a fuel cell stack for use in automobiles.

### BACKGROUND

Generally, a fuel cell stack should continuously be provided with air, hydrogen, and coolant. Thus a fuel cell stack requires fluid-tightness, and structural as well as electrical stabilities. Embodiments of the present invention provide improved fluid-tightness, structural stability, and electrical stability for a fuel cell stack.

### SUMMARY

A fuel cell stack structure according to one embodiment includes unit modules having fuel cells, each fuel cell comprising a membrane electrode assembly (MEA) and separator plates. A current collecting plate is disposed at both distal sides of the fuel cells stacked one after another in a row. An insulating plate is identical in shape to the body of the current collecting plate and is disposed at the external side of the current collecting plate. An end plate is placed at the external side of the insulating plate and is provided at the outer surface thereof with a plurality of reinforcing ribs. Fixing bands connect the end plates for fixing and supporting purposes. A common distributor provides hydrogen, air, and coolant to the unit modules. A bus bar electrically connects the unit modules.

### BRIEF DESCRIPTION OF THE DRAWINGS

For a better understanding of the nature and objects of the present invention, reference should be made to the following detailed description with the accompanying drawings, in which:

FIG. 1 is an external view of a fuel cell stack according to one embodiment;

FIG. 2 is an exploded perspective view of FIG. 1;

FIG. 3 is an exploded perspective view of a unit module;

FIG. 4 illustrates a structure of a fixing band;

FIG. 5 illustrates a structure of a bus bar;

FIG. 6 illustrates a module coupling bolt and relevant components thereof,

FIG. 7 illustrates an installation structure of gaskets between a common distributor and unit module;

FIG. 8 illustrates a structure of an insulating plate having one concavo-convex surface; and

FIG. 9 illustrates a structure of an insulating plate having two concavo-convex surfaces.

### DETAILED DESCRIPTION OF THE EMBODIMENTS

While the invention will be described in conjunction with the embodiments, it is not intended to limit the invention to these particular embodiments. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks well known to those of ordinary skill in the art are not described in detail to avoid obscuring aspects of the present invention.

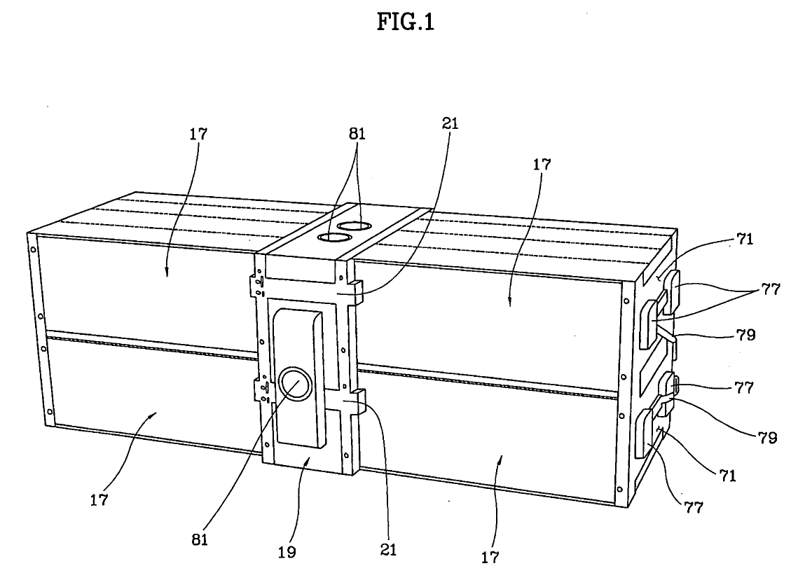

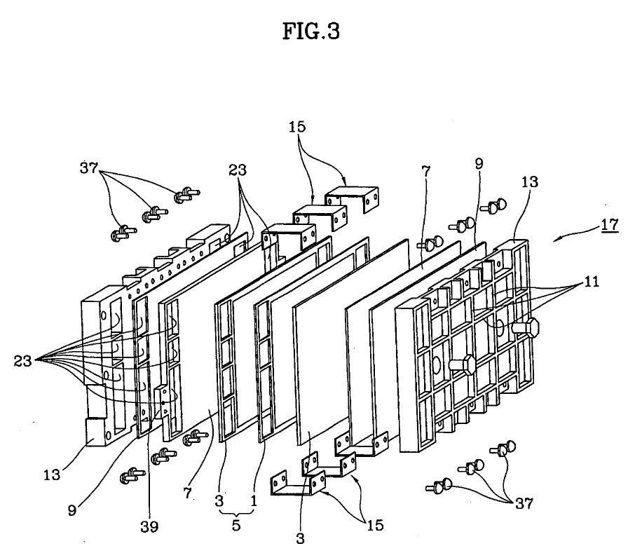

Referring to FIGS. 1 to 3, a unit module 17 includes fuel cells 5, current collecting plates 7, insulating plates 9, end plates 13, and a plurality of fixing bands 15. For ease of reference, a unit module having a single fuel cell is depicted in FIG. 3. Each fuel cell 5 comprises a membrane electrode assembly (MEA) 1 between separator plates 3. A current collecting plate 7 is disposed on each side of fuel cells 5. The fuel cells 5 are stacked one after another in a row between the current collecting plates 7. Insulating plates 9 lack the current outflow portion 39 of the current collecting plate, but are otherwise identical in shape to the current collecting plates 7 and placed outside of the current collecting plates 7. An end plate 13 is placed outside of each insulating plate 9. Each outer surface of end plates 13 has a plurality of reinforcing ribs 11. Fixing bands 15 connect two end plates 13 for fixing and supporting purposes as shown by the dashed lines in FIG. 3. A common distributor 19 provides hydrogen, air, and coolant to unit modules 17. A bus bar 21 electrically connects unit modules 17.

Insulating plate 9 has the same shape as current collecting plate 7 for a virtually complete prevention of electrical leakage from current collecting plate 7 to the exterior of the unit module 17. Reinforcing ribs 11 at the outer surface of end plates 13 serve to evenly disperse the load generated by fixing bands 15 on fuel cells 5, thus preventing the separator plates 3 from fracturing. The reinforcing ribs 11 also serve to prevent different fuel cell performance due to different pressure on each side of fuel cell 5.

End plate 13, insulating plate 9, and current collecting plate 7 located at the side of unit module 17 to be positioned nearest the common distributor 19 have communication holes 23 at both ends forming passages for fluids (e.g. hydrogen, air, coolant) to flow from the common distributor 19 to the fuel cells 5. End plate 13, insulating plate 9, and current collecting plate 7 at the outside of unit module 17 (located farthest from the common distributor 19 and shown on the right side of FIG. 3) have no holes at either end. MEA 1 and separator plate 3 also have communication holes 23 for the flow of fluids therethrough. However, the outermost separator plate 3 for the very farthest fuel cell 5 in the stack from the common distributor 19 has no holes.

The fluid delivered from common distributor 19 passes through communication holes 23 on one end of end plate 13, insulating plate 9, and current collecting plate 7 to be supplied into each fuel cell 5 and then is discharged through communication holes 23 at the other end of current collecting plate 7, insulating plate 9, and end plate 13. While, FIG. 1 shows four unit modules 17 having a single common distributor 19, in some embodiments the number and shape of the elements may be different. For example, the fuel stack structure may contain six unit modules 17 and have a common distributor in the shape of an octagon.

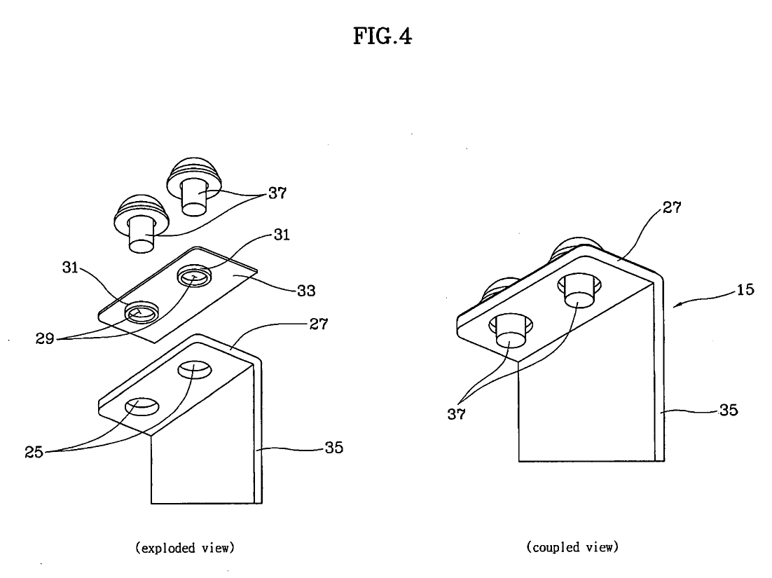

In reference to FIG. 4, fixing bands 15 include band heads 27 that enclose the outer surface of end plate 13 and have a plurality of coupling holes 25. (The second band head 27 is not shown in FIG. 4.) An insulator 33 is inserted into coupling hole 25 of band head 27 and is integrally formed with insulating bosses 31 having bolt through holes 29 therein. Band heads 27 of fixing band 15 together with a band body 35 that connects band heads 27 are coated with an insulating material on all surfaces. Thus, fixing bands 15 are completely electrically isolated from fuel cells 5 in unit module 17.

Fixing bands 15 along with end plates 13 rigidly stabilize unit module 17 without electrical leakage. That is, band heads 27 of fixing band 15 are coupled to end plate 13 with band bolts 37, and insulator 33 keeps end plate 13 electrically isolated from fixing bands 15. As band bolts 37 do not directly contact coupling holes 25 of band heads 27, the insulating coating layer of fixing band 15 is not damaged during the assembly of band bolts 37, and end plate 13 and fixing band 15 are not electrically connected to each other via band bolts 37.

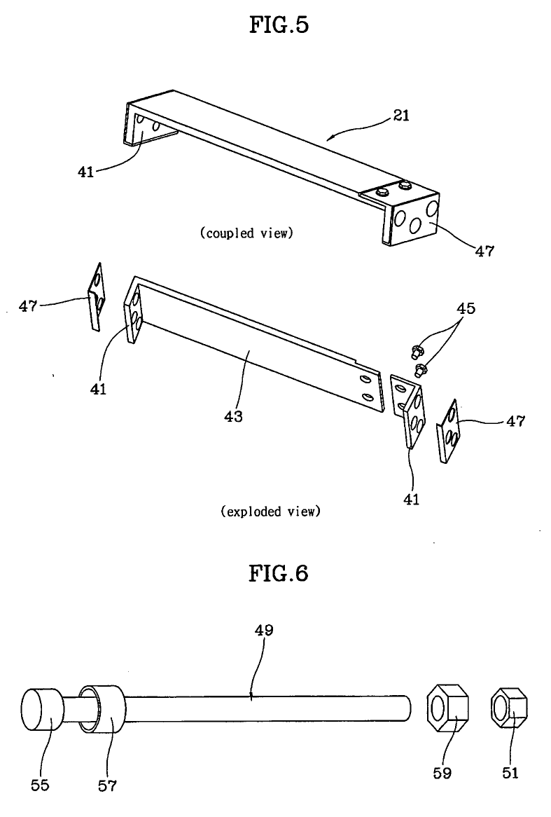

Current collecting plate 7 is integrally formed with a current outflow portion 39 protruding from one side of unit module 17 to thereby electrically connect unit modules 17 using bus bar 21. Bus bar 21 is in an elongated, conducting bar with both ends bent in one direction as shown in FIG. 5. Bus bar 21 includes bus bar heads 41 at both ends and a bus bar body 43 connecting bus bar heads 41. The bus bar body 43 comprises two separate parts 43a and 43b coupled by connecting bolts 45. Insulating covers 47 attach to bus bar heads 41. The outside of bus bar body 43 is coated with an insulating material, as shown by cross-hatching in the coupled view of FIG. 5.

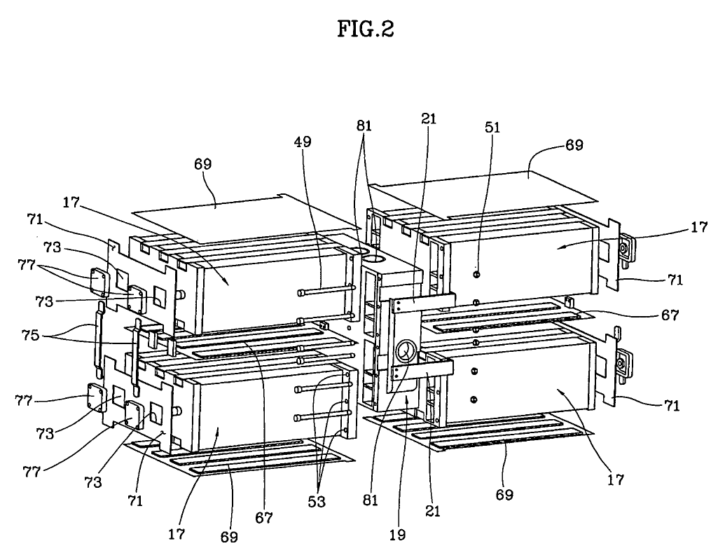

In order to electrically connect two unit modules 17 via bus bar 21, the bus bar heads 41 of bus bar 21 are each fixed to the current outflow portion 39 of the current collecting plate 7 of each unit module 17 while the bus bar body 43 is in two separate parts, as shown in FIG. 2. Then, the separated parts of bus bar body 43 are coupled to each other via connecting bolts 45. Since bus bar heads 41 are coupled to current outflow portion 39 of the current collecting plate 7 in advance, current collecting plate 7 and bus bar 21 have superior electrical contact, and any disparity in the connecting surfaces of bus bar 21 and current collecting plate 7 due to manufacturing tolerances may be compensated for by bus bar body 43. Also, the insulating coating on the outside of the bus bar body 43 and insulating cover 47 safely prevent electrical leakage to the exterior of the fuel stack structure.

With reference to FIGS. 2 and 6, two types of end plates 13 may face each other across common distributor 19, wherein the first type of end plate 13 is formed with a plurality of bolt holes 53 through which module coupling bolts 49 pass through to couple with common distributor 19, and the second type of end plate 13 has nuts 51 therein to be coupled with module coupling bolts 49. Bolt head covers 57 are inserted into end plate 13 having bolt holes 53 so as to avoid contact between bolt heads 55 and end plate 13. Nut covers 59 are inserted into the end plate 13 having nuts 51 therein so as to enclose nuts 51 and prevent contact between nuts 51 and end plate 13. Thus, two unit modules 17 may be tightly coupled to each other via module coupling bolts 49 passing through common distributor 19; while end plates 13 are completely electrically isolated by bolt head covers 57 and nut covers 59.

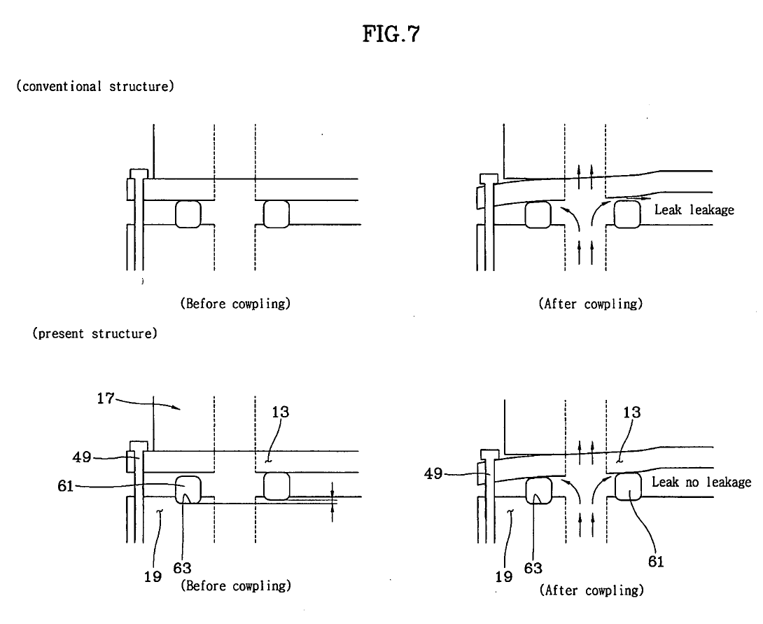

As illustrated in FIG. 7, gaskets 61 are mounted on the surface of common distributor 19 facing end plate 13, to prevent fluid leakage therethrough. The gasket groove near where module coupling bolts 49 pass through common distributor 19 is deeper than other gasket grooves 63 into which gaskets 61 are inserted. Therefore, even after end plate 13 partially deforms when the module coupling bolts 49 are bolted to common distributor 19, no fluid leaks between end plate 13 and common distributor 19. This configuration of gaskets 61 and gasket grooves 63 also seals the common distributor 19 more tightly to the end plates 13. In some embodiments, leaks are prevented by forming gasket grooves 63 of different depths to compensate for the partial deformation of end plate 13. In other embodiments, the gaskets 61 may vary in thickness to compensate for the deformation of end plate 13 while maintaining gasket grooves 63 at a fixed depth.

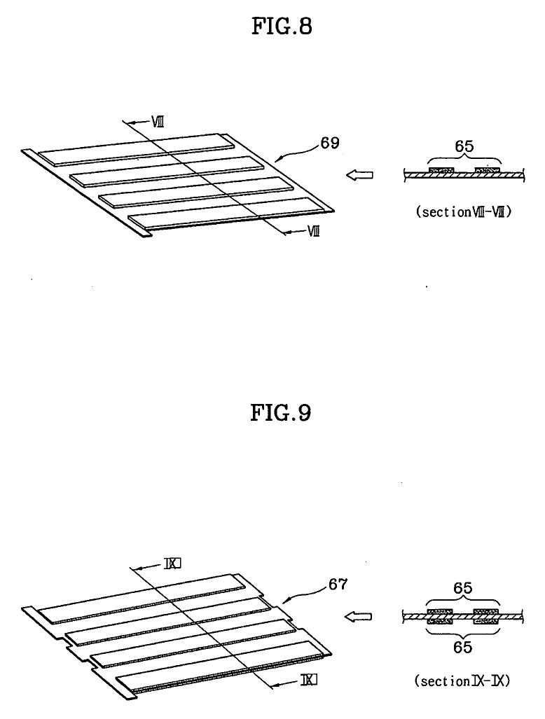

Referring now to FIGS. 2, 8, and 9, an insulating layer 67 having uneven portions 65 on both upper and lower surfaces thereof for accommodating fixing band 15, is mounted between unit modules 17 that are stacked one upon the other. An insulating layer 69 having one surface with uneven portions 65 for accommodating fixing band 15 is installed on the farthest upper and lower surfaces of the stack of unit modules 17. Uneven portions 65 represent insulated protrusions from a flat layer.

The external side of end plate 13, opposite where unit module 17 connects to common distributor 19, is installed with an insulating cover 71 for insulation from the exterior. Accordingly, unit modules 17 are electrically isolated from each other and from the environment outside the stack. As shown in the left side of FIG. 2, the upper and lower unit modules 17 may be connected in series via vertical serial bus bars 75 inserted into serial connecting holes 73 formed at insulating covers 71. Serial connecting holes 73 are sealed by hole covers 77.

The complete assembly of the right side of FIG. 2 is depicted in the right side of FIG. 1, wherein terminal plates 79 connected to each of upper and lower unit modules 17 are configured to discharge current to the exterior of the stack. The common distributor 19 is formed with inflow/outflow holes 81 for hydrogen, air, and coolant.

As apparent from the foregoing, improved fluid tightness, as well as structural and electrical stabilities, is provided in the fuel cell stack. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A fuel cell stack structure, comprising:
a plurality of unit modules comprising:
at least one fuel cell;
a current collecting plate pair, wherein each current collecting plate of said current collecting plate pair is respectively disposed at opposite sides of said fuel cell;
an insulating plate pair, wherein each insulating plate is respectively disposed at a distal side of each current collecting plate;
an end plate pair, wherein each end plate of said end plate pair is respectively disposed at a distal side of each insulating plate; and
fixing bands connecting said end plates;
a common distributor providing hydrogen, air, and coolant to said unit modules; and
a bus bar electrically connecting said unit modules.

2. The structure as defined in claim 1, wherein:
a first one of said end plate pair, a first one of said insulating plate pair, and a first one of said current collecting plate pair disposed at a first side of said unit module are formed at both ends thereof with communication holes; and
a second one of said end plate pair, a second one of said insulating plate pair, and a second one of said current collecting plate pair disposed at a second side of said unit module are formed without communication holes.

3. The structure as defined in claim 1, wherein each of said fixing bands comprises:
a pair of band heads enclosing an outer surface of said end plate and having a plurality of coupling holes; and
an insulator inserted into said coupling holes of said band heads and integrally formed with insulating bosses having bolt holes therein.

4. The structure as defined in claim 3, wherein:
said fixing band includes a band body connecting said band heads; and
said band heads and said band body are coated with an insulating material on outer surfaces thereof

5. The structure as defined in claim 2, wherein said first current collecting plate is integrally formed with a current outflow portion protruding from a side of said unit module perpendicular to said first side of said unit module.

6. The structure as defined in claim 1, wherein said bus bar has an elongated bar shape and includes:
a pair of bus bar heads disposed at both ends of said bus bar and bent in a first direction;
a bus bar body connecting said bus bar heads, wherein said bus bar body comprises a pair of separate parts coupled by connecting bolts and said bus bar body is coated with an insulating material; and
an insulating cover attached to said bus bar heads.

7. The structure as defined in claim 1, wherein at least one of said end plate pair comprises one of:
a first type of end plate formed with a plurality of bolt holes through which a plurality of module coupling bolts, having bolt heads, pass to couple with said common distributor wherein a plurality of bolt head covers are inserted into said first type of end plate thereby separating said bolt heads from said first type of end plate; and
a second type of end plate having a plurality of nuts to be coupled with said module coupling bolts wherein a plurality of nut covers are inserted into said second type of end plate thereby enclosing said nuts and separating a contact of said nuts and said end plate;
and wherein said first type of end plate of a first unit module faces said second type of end plate of a second unit module and said first type of end plate and said second type of end plate are coupled together by said module coupling bolts passing through said common distributor.

8. The structure as defined in claim 2, wherein a surface of said common distributor facing said first one of said end plate pair includes a plurality of gasket grooves into each one of which a gasket is inserted, said gasket grooves including a first subset nearer said module coupling bolts than a second subset, wherein said first subset of said gasket grooves is deeper than said second subset.

9. The structure as defined in claim 1, further comprising:
at least one first insulating layer having uneven portions on both upper and lower surfaces thereof for accommodating said fixing bands, said first insulating layer mounted between said unit modules;
at least one second insulating layer having uneven portions for accommodating said fixing bands on a lower surface thereof, said second insulating layer mounted on a farthest upper surface of said unit module stack; and
at least one third insulating layer having uneven portions for accommodating said fixing bands on an upper surface thereof, said third insulating layer mounted on a farthest lower surface of said unit module stack.

10. The structure as defined in claim 2, wherein an external side of said second one of said end plate paid opposite a connection between said unit module and said common distributor, is installed with an insulating cover.

11. The structure as defined in claim 1, said fuel cell comprising a membrane electrode assembly between separator plates; said unit modules comprising:

12. The structure as defined in claim 1, wherein said at least one fuel cell comprising a plurality of fuel cells stacked in a row.

13. The structure as defined in claim 5, wherein said first insulating plate is substantially identical in shape to a body of said first current collecting plate not including said current outflow portion and said second insulating plate is substantially identical in shape to said second current collecting plate.

14. The structure as defined in claim 1, wherein each end plate is formed at an outer surface thereof with a plurality of reinforcing ribs.

15. A fuel cell stack structure, comprising:
a plurality of unit modules including fuel cells, each fuel cell comprising a membrane electrode assembly and separator plates; said unit module comprising:
means for collecting current at both sides of said fuel cells;
means for insulating disposed outside of said means for collecting current;
means for stabilizing said unit module disposed outside of said means for insulating and having means for reinforcing an outer surface thereof; and
means for connecting said means for stabilizing;
means for providing hydrogen, air, and coolant to said unit modules; and
means for electrically connecting said unit modules.

16. A method of stacking fuels cells in a structure, comprising:
assembling a plurality of unit modules, comprising:
stacking fuel cells in a row;
collecting current with first plates on both sides of said row of fuel cells;
providing insulation with second plates on a side of said first plates facing away from said row of fuel cells; and
stabilizing said unit modules; and
providing hydrogen, air, and coolant to said unit modules; and
electrically connecting said unit modules.

17. The method of claim 16, further comprising electrically isolating said structure.

18. The method of claim 17, wherein electrically connecting said unit modules comprises:
fixing a first portion of a bus bar to a first unit module;
fixing a second portion of said bus bar to a second unit module; and
coupling said first and second portions of said bus bar body.

19. The method of claim 16, wherein providing hydrogen, air, and coolant to said unit modules comprises:
coupling one of said pair of end plates of each of a pair of unit modules with module coupling bolts passing through a common distributor of hydrogen, air, and coolant;
forming a passage for hydrogen, air, and coolant from said common distributor through said one of said pair of end plates on a first side of said row of fuels, a second plate on said first side of said row of fuels, and a first plate on said first side of said row of fuels to said fuel cells; and
forming a second passage returning to said common distributor from said row of fuel cells.

20. The method of claim 16, wherein stabilizing said unit modules providing a pair of end plates placed at a side of said second plates facing away from said row of fuel cells;
reinforcing said end plates; and
connecting said end plates.
